(19) United States
(12) Patent Application Publication
(10) Pub. No.: US 2013/0342928 A1
(43) Pub. Date: Dec. 26, 2013

(54) INFORMATION PROCESSING DEVICE, INFORMATION PROCESSING METHOD, AND STORAGE MEDIUM

(71) Applicant: FUJITSU LIMITED, Kawasaki-shi (JP)

(72) Inventor: Takayuki NIIYAMA, Kawasaki (JP)

(73) Assignee: FUJITSU LIMITED, Kawasaki-shi (JP)

(21) Appl. No.: 13/974,668

(22) Filed: Aug. 23, 2013

Related U.S. Application Data
(63) Continuation of application No. PCT/JP2011/001657, filed on Mar. 18, 2011.

(51) Int. Cl. G11B 19/04

(52) U.S. Cl. CPC G11B 19/043
USPC 360/6

(57) ABSTRACT

An information processing device includes an acceleration sensor that detects an acceleration; a processor that is coupled to the acceleration sensor and configured to: cause a storage that is included in the information processing device to execute crash-proof processing based on the acceleration detected by the acceleration sensor, and cause the storage to terminate the crash-proof processing when the processor detects that an external device is mechanically coupled to the information processing device.

### CROSS-REFERENCE TO RELATED APPLICATION

This is a continuation application of International Application PCT/JP2011-001657, filed on Mar. 18, 2011, and designated the U.S., the entire contents of which are incorporated herein by reference.

### FIELD

The embodiments discussed herein are related to an information processing device, an information processing method, and a storage medium.

### BACKGROUND

There is a function that executes, for example, crash-proof processing of mechanically retracting a head of a hard disk drive (HDD) at the time of fall of an information processing device or the like. The detection of fall is performed by an acceleration sensor or the like, and it is determined that the device is falling when the acceleration of the device becomes a certain value or more.

In the method of detecting fall using the acceleration sensor, in a case in which a shake due to touching or the like is merely given to the information processing device, fall is detected by mistake when the acceleration becomes a certain value or more.

For example, there is a technology by which a fall determination condition is controlled in accordance with an operation mode of a recording device (for example, Japanese Laid-open Patent Publication No. 2005-44435).

In addition, for example, there is a technology by which a fall state of a device is detected from an output signal of the acceleration sensor (for example, Japanese Laid-open Patent Publication No. 2007-95182).

In a case in which the sensitivity for detection of an impact is high in the device, the crash-proof processing is undesirably executed when an external device is coupled to the device. In addition, it takes time for return of the HDD because a warning is displayed on a screen, for example, so that a user feels the inconvenience. In addition, when the sensitivity for detection of an impact is reduced and it is set that the crash-proof processing due to the false detection is not executed, detection of an impact to be originally detected such as the fall of the device is undesirably delayed.

### SUMMARY

According to an aspect of the invention, an information processing device includes an acceleration sensor that detects an acceleration; a processor that is coupled to the acceleration sensor and configured to: cause a storage that is included in the information processing device to execute crash-proof processing based on the acceleration detected by the acceleration sensor, and cause the storage to terminate the crash-proof processing when the processor detects that an external device is mechanically coupled to the information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a first example of a hardware configuration of an information processing device;

FIG. 2 is a diagram illustrating an appearance of the information processing device;

FIG. 3 is a block diagram illustrating a first example of a configuration of a central processing unit (CPU) and a peripheral device;

FIG. 4 is a diagram illustrating a method of detecting connection of an external device;

FIG. 5 is a diagram illustrating a first example of an output of an acceleration sensor;

FIG. 6 is a diagram illustrating a warning message;

FIG. 7 is a flowchart illustrating a first example of processing according to an embodiment;

FIG. 8 is a block diagram illustrating a second example of the configuration of the CPU and the peripheral device;

FIG. 9 is a diagram illustrating a second example of the output of the acceleration sensor; and

FIG. 10 is a flowchart illustrating a second example of the processing according to the embodiment.

### DESCRIPTION OF EMBODIMENTS

An information processing device according to an embodiment is described below.

### First Embodiment

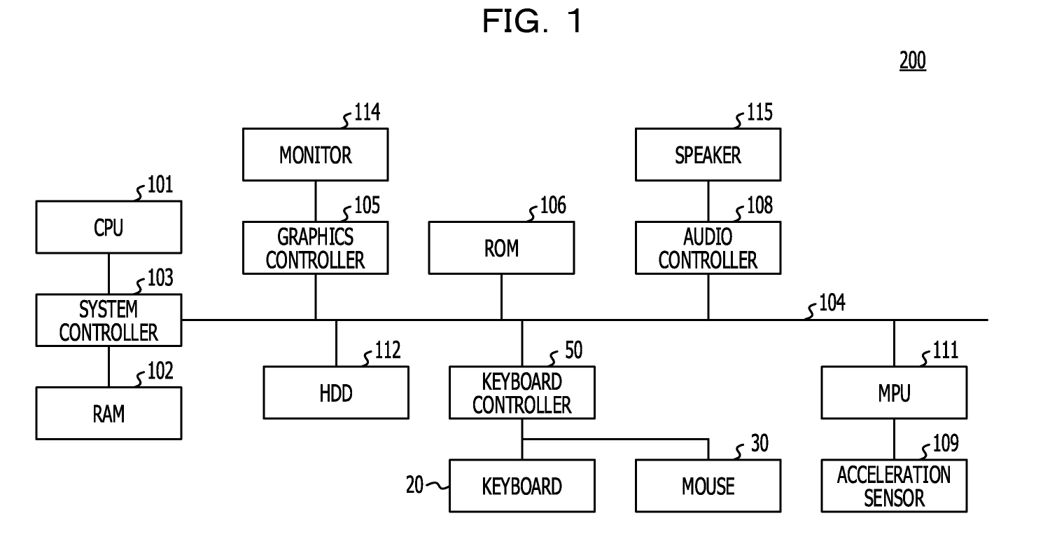

FIG. 1 is a block diagram illustrating an example of a hardware configuration of an information processing device 200 according to the embodiment. The whole information processing device 200 is controlled by a CPU 101.

A system controller 103 is coupled to the CPU 101 and a random access memory (RAM) 102. The system controller 103 controls data transfer between the CPU 101 and the RAM 102 and data transfer between the CPU 101 and a bus 104. In addition, a graphics controller 105, a read only memory (ROM) 106, an audio controller 108, a micro processing unit (MPU) 111, a keyboard controller 50, and a hard disk drive (HDD) 112 are coupled to the system controller 103 through the bus 104.

At least a part of an application program or a program of an operating system (OS) that the CPU 101 is caused to execute is temporarily stored in the RAM 102. Various pieces of data that are desired for processing by the CPU 101 are stored in the RAM 102.

A monitor 114 such as a liquid crystal monitor (LCD) is coupled to the graphics controller 105. The graphics controller 105 causes an image to be displayed on a screen of the monitor 114 in response to an instruction from the CPU 101.

For example, a basic input/output system (BIOS) program is stored in the ROM 106.

A speaker 115 is coupled to the audio controller 108. The audio controller 108 causes sound to be generated from the speaker 115 in response to the instruction from the CPU 101.

The MPU 111 is coupled to an acceleration sensor 109. The MPU 111 transmits a value that is obtained from the acceleration sensor 109, to the CPU 101. The acceleration sensor 109 detects variation in an acceleration that is applied, for example, on each of two axes (X and Y axes) or three axes (X, Y, and Z axes), and performs analogue output.

A keyboard 20 and a mouse 30 are coupled to the keyboard controller 50. The keyboard controller 50 transmits a signal that is transmitted from the keyboard 20 or the mouse 30, to the CPU 101 through the bus 104.

The HDD 112 includes a hard disk that is a medium and a head that is used to perform access for reading from the hard disk and writing to the medium. In the hard disk, an OS, a program of an application, and various pieces of data are stored.

By using such hardware configuration, a processing function of the information processing device 200 may be realized.

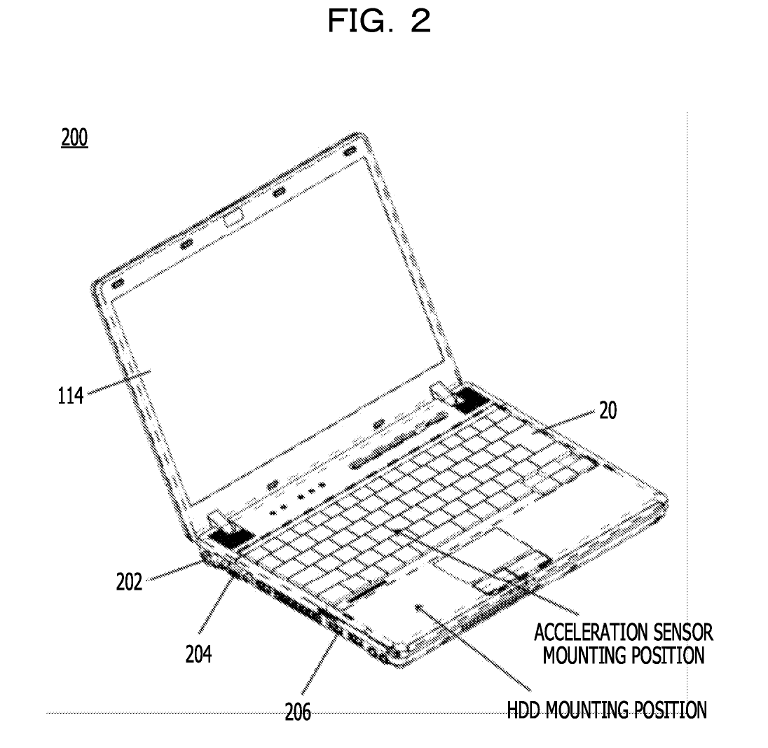

FIG. 2 is a diagram illustrating an appearance of the information processing device 200 according to the embodiment. The information processing device 200 includes a direct current (DC)-IN connector 202, a cathode ray tube (CRT) connector 204, and a Universal Serial Bus (USB) connector 206. The DC-IN connector 202, the CRT connector 204, and the USB connector 206 are connectors to and from which the external device may be mechanically attached and detached.

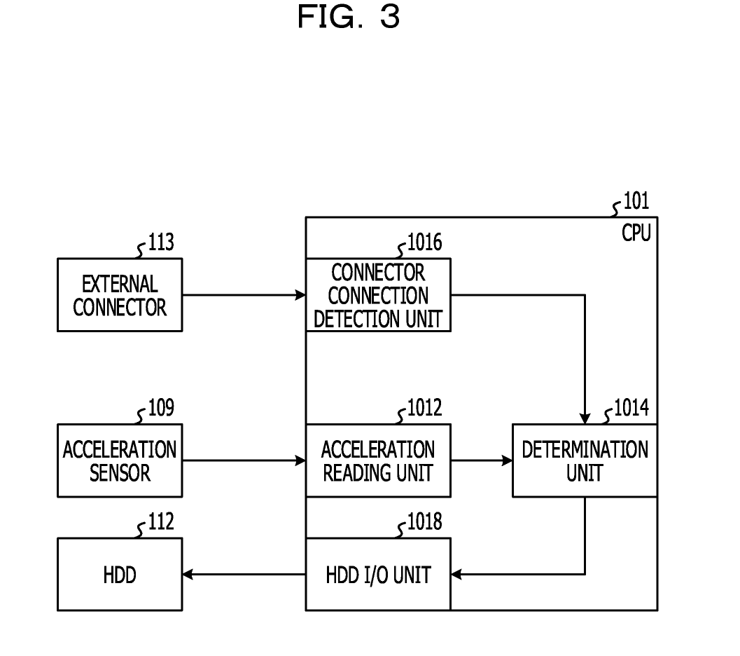

FIG. 3 is a block diagram illustrating in outline an example of a configuration of the CPU 101 and the peripheral device according to the embodiment.

The CPU 101 functions as an acceleration reading unit 1012, a determination unit 1014, a connector connection detection unit 1016, and an HDD I/O unit 1018.

The acceleration reading unit 1012 obtains an acceleration value from the acceleration sensor 109 and transfers the data to the determination unit 1014.

The determination unit 1014 determines whether the read acceleration value is a certain value or more, and instructs the HDD I/O unit 1018 to retract the head, on the basis of the determination result. The determination unit 1014 instructs the HDD I/O unit 1018 to return the head.

The connector connection detection unit 1016 detects connection of an external connector 113. The connector connection detection unit 1016 detects the connection of the external connector 113 at the time of rise/fall of a signal that is used to detect the connection of the connector.

The HDD I/O unit 1018 controls the I/O of the HDD 112. When the HDD I/O unit 1018 receives an instruction of retraction of the head from the determination unit 1014, the HDD I/O unit 1018 issues a command to cause the head to be retracted, to the HDD 112, and executes the retraction of the head. When the HDD I/O unit 1018 receives an instruction of return of the head from the determination unit 1014, the HDD I/O unit 1018 issues a command to cause the head to be returned, to the HDD 112, and executes the return of the head.

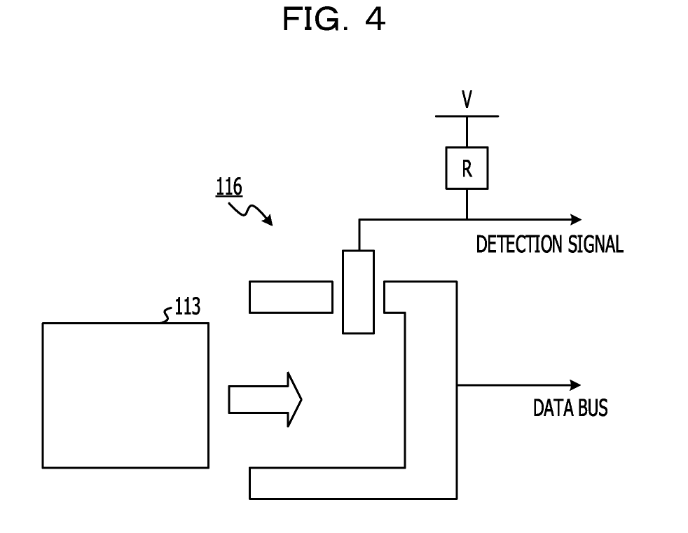

FIG. 4 is a diagram illustrating a method of detecting external device connection according to the embodiment. When the external connector 113 is coupled to an information processing device side connector 116, for example, a detection signal is changed from “High” to “Low”. “High” of the detection signal indicates that the external device is not coupled to the information processing device 200. “Low” of the detection signal indicates that the external device is coupled to the information processing device 200. The detection signal is input to the connector connection detection unit 1016. The connector connection detection unit 1016 determines whether or not the external device is coupled to the information processing device 200 by determining whether the detection signal is “High” or “Low”.

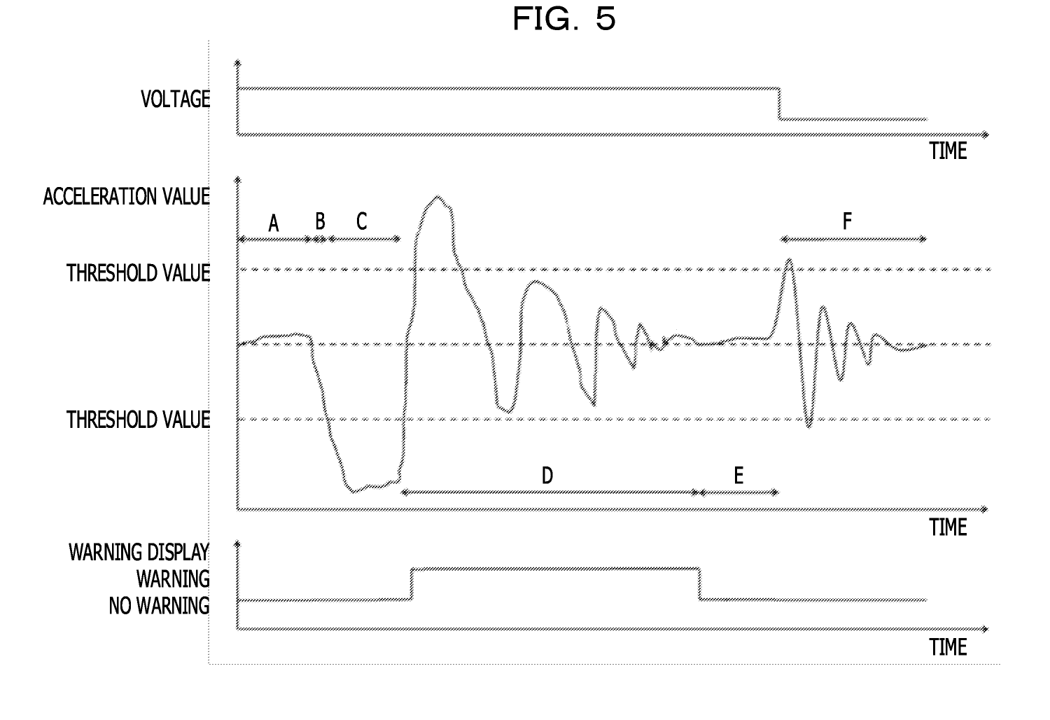

FIG. 5 is a diagram illustrating a relationship between change in an output of the acceleration sensor 109 that is included in the information processing device 200 according to the embodiment, voltage that is detected by the connector connection detection unit 1016, and timing at which the CPU 101 performs warning display.

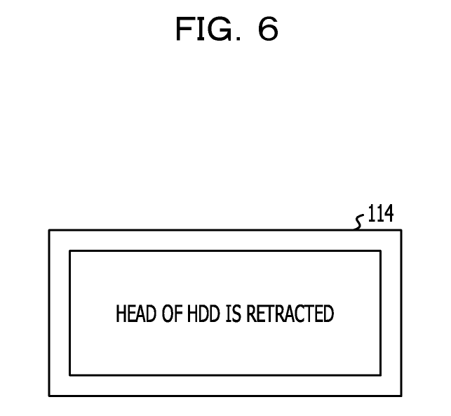

First, for example, as illustrated in the section A of FIG. 5, when the information processing device 200 is in a regular movement state in which the user holds the information processing device 200, an output of the acceleration sensor 109 is changed relatively smoothly. Next, as illustrated in the section B of FIG. 5, the information processing device 200 is in a gravity-free state as the information processing device 200 falls, the acceleration is rapidly changed, an output level of the acceleration sensor 109 is also rapidly changed. In addition, as illustrated in the section C of FIG. 5, the acceleration in a case of free fall becomes substantially even. In the sections B and C, when the acceleration value exceeds a certain value, the determination unit 1014 outputs a retraction instruction to the HDD I/O unit 1018 and causes the HDD I/O unit 1018 to execute processing of retracting the head of the HDD 112 in order to execute the crash-proof processing of the information processing device 200. The determination unit 1014 displays a message that indicates that retraction of the head of the HDD has been performed, on the monitor 114 through the graphics controller 105. FIG. 6 is an example of a warning message that is displayed on the monitor 114.

After that, as illustrated in the section D of FIG. 5, for example, when the fall of the device is avoided by the user before the information processing device 200 falls on a floor, the output level of the acceleration sensor 109 rises rapidly. After that, until the information processing device 200 is caused to become the static state by the user, the output level of the acceleration sensor 109 moves up and down repeatedly. At that time, the head of the HDD 112 is not damaged because the head has been moved to the retraction location already. The determination unit 1014 terminates the display of the message that indicates that the head retraction of the HDD has been performed, on the monitor 114 through the graphics controller 105.

In a case in which the information processing device 200 becomes, for example, in the static state when the information processing device 200 is put on a desk, or the like by the user, the acceleration sensor 109 becomes in a state in which gravity force alone is applied to the acceleration sensor 109. Subsequently, as illustrated in the section E of FIG. 5, the output level of the acceleration sensor 109 becomes substantially even.

In addition, when the external device is mechanically coupled to the information processing device 200 by the user, as illustrated in the section F of FIG. 5, the output level of the acceleration sensor 109 rises rapidly due to an impact that is applied to the information processing device 200, at the time of connection of the external device. After that, until the information processing device 200 becomes in the static state, the output level of the acceleration sensor 109 moves up and down repeatedly. At the time of connection of the external device, the determination unit 1014 determines that the external device is mechanically coupled to the information processing device 200 on the basis of the voltage that is detected by the connector connection detection unit 1016. The determination unit 1014 does not perform the display of the message that indicates that the head retraction of the HDD has been performed on the monitor 114 through the graphics controller 105.

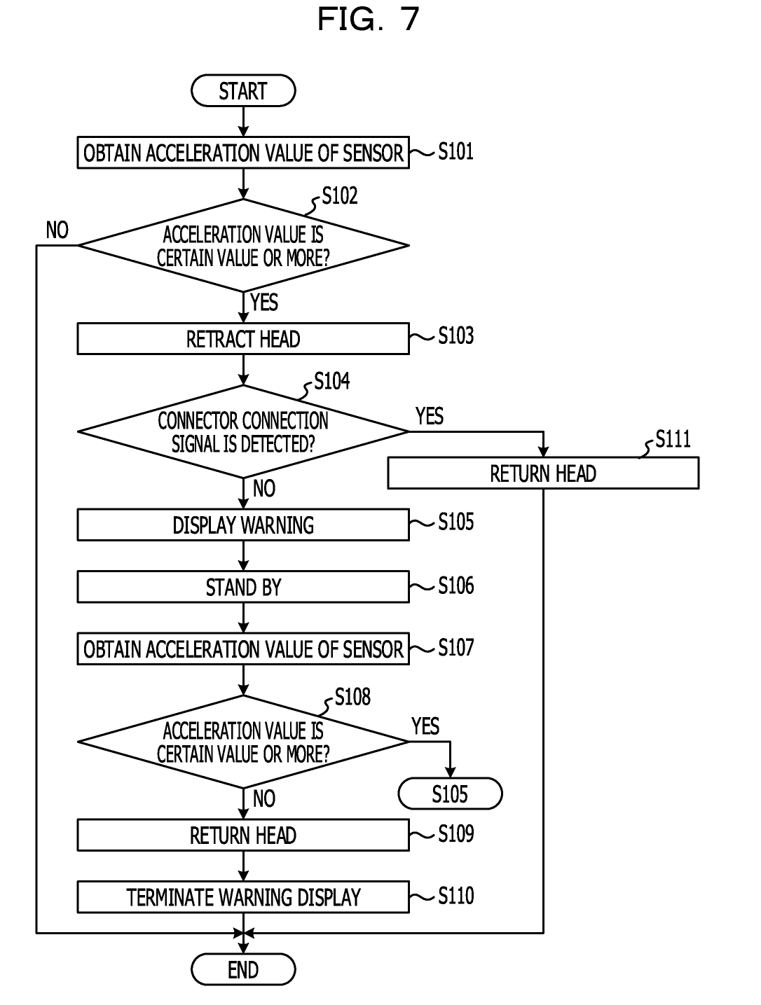

FIG. 7 is a flowchart of the processing according to the embodiment.

In S101, the acceleration reading unit 1012 obtains an acceleration value from the acceleration sensor 109 and transfers the obtained acceleration value to the determination unit 1014. The flow proceeds to S102.

In S102, the determination unit 1014 determines whether or not the acceleration value that is transferred from the acceleration reading unit 1012 is a certain value or more. As illustrated in the section C of FIG. 5, when the acceleration value is the certain value or more, the flow proceeds to S103. In addition, as illustrated in the section A of FIG. 5, when the acceleration value is less than the certain value, the flow ends.

In S103, the determination unit 1014 instructs the HDD I/O unit 1018 to retract the head of the HDD 112. When the HDD I/O unit 1018 receives the instruction of the head retraction from the determination unit 1014, the HDD I/O unit 1018 retracts the head of the HDD 112. The flow proceeds to S104.

In S104, the determination unit 1014 determines whether or not the connector connection detection unit 1016 detects connection of the external connector 113. As illustrated in the section F of FIG. 5, when the connector connection detection unit 1016 detects the connection of the external connector 113, the flow proceeds to S111. In addition, as illustrated in the section D of FIG. 5, when the connector connection detection unit 1016 does not detect the connection of the external connector 113, the flow proceeds to S105.

In S105, the determination unit 1014 displays the warning message on the monitor 114 through the system controller 103 and the graphics controller 105. The warning message is illustrated in FIG. 6. The flow proceeds to S106.

In S106, the HDD I/O unit 1018 causes the head of the HDD 112 to stand by at the refraction location. The flow proceeds to S107.

In S107, the acceleration reading unit 1012 obtains an acceleration value from the acceleration sensor 109 again after a certain time elapses, and transfers the obtained acceleration value to the determination unit 1014. The flow proceeds to S108.

In S108, the determination unit 1014 determines whether or not the acceleration value that is transferred from the acceleration reading unit 1012 is a certain value or more. As illustrated in the section C of FIG. 5, when the acceleration value is the certain value or more, the information processing device 200 is not in the static state, so that it is probable that the crash occurs when the head is returned. Therefore, the flow returns to S105. In addition, as illustrated in the section E of FIG. 5, when the acceleration value is less than the certain value, the information processing device 200 is in the static state, so that there is no possibility that the crash occurs even when the head is returned. Therefore, the flow proceeds to S109.

In S109, the determination unit 1014 instructs the HDD I/O unit 1018 to return the head of the HDD 112. When the HDD I/O unit 1018 receives the instruction of return of the head from the determination unit 1014, the HDD I/O unit 1018 returns the head of the HDD 112. The flow proceeds to S110.

In S110, the CPU 101 terminates the display of the warning message that has been displayed on the monitor 114 through the system controller 103 and the graphics controller 105. The flow ends.

Here, a case is described in which the connector connection detection unit 1016 detects the connection of the external connector 113 in S104,. As illustrated in the section F of FIG. 5, even in a case in which the acceleration value exceeds the certain value, when the connector connection detection unit 1016 detects that the external device is mechanically coupled to the information processing device 200, the determination unit 1014 determines that an impact is applied to the information processing device 200 because the external device is mechanically coupled to the information processing device 200. The determination unit 1014 terminates the crash-proof processing of the information processing device 200.

In S111, the determination unit 1014 instructs the HDD I/O unit 1018 to return the head of the HDD 112. When the HDD I/O unit 1018 receives the instruction of return of the head from the determination unit 1014, the HDD I/O unit 1018 returns the head of the HDD 112. After the processing in S111, the processing according to the embodiment ends.

As described above, in the first embodiment, in the case in which an impact is temporarily applied to the information processing device 200, when it is detected that the external device is mechanically coupled to the information processing device 200, the return of the HDD from the protected state is advanced. Therefore, a head retraction time period may be reduced. In the first embodiment, even when the function of protecting the HDD is excessively performed for an impact that occurs at the time of mechanical connection of the external device, the head is returned immediately. Therefore, the user will not feel the inconvenience.

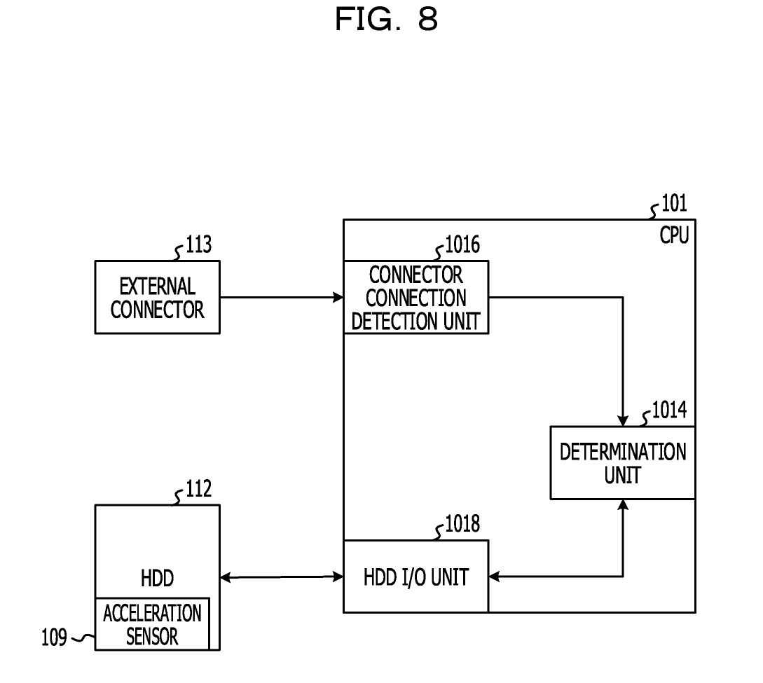

In the first embodiment, the case is described above in which the acceleration sensor 109 is not built into the HDD 112, however as illustrated in FIG. 8, the acceleration sensor 109 may be built into the HDD 112. In this case, the HDD I/O unit 1018 obtains an acceleration value from the acceleration sensor 109, and transfers the data to the determination unit 1014.

In the first embodiment, the case is described above in which the mechanical connection of the external device to the information processing device 200 is detected, however, for example, the connection of the external device to the information processing device 200 may be detected using the plug-in function.

### Second Embodiment

In the first embodiment, the case is described above in which the external device is mechanically coupled to the information processing device 200. In a second embodiment, a case is described in which the external device is mechanically disconnected from the information processing device 200.

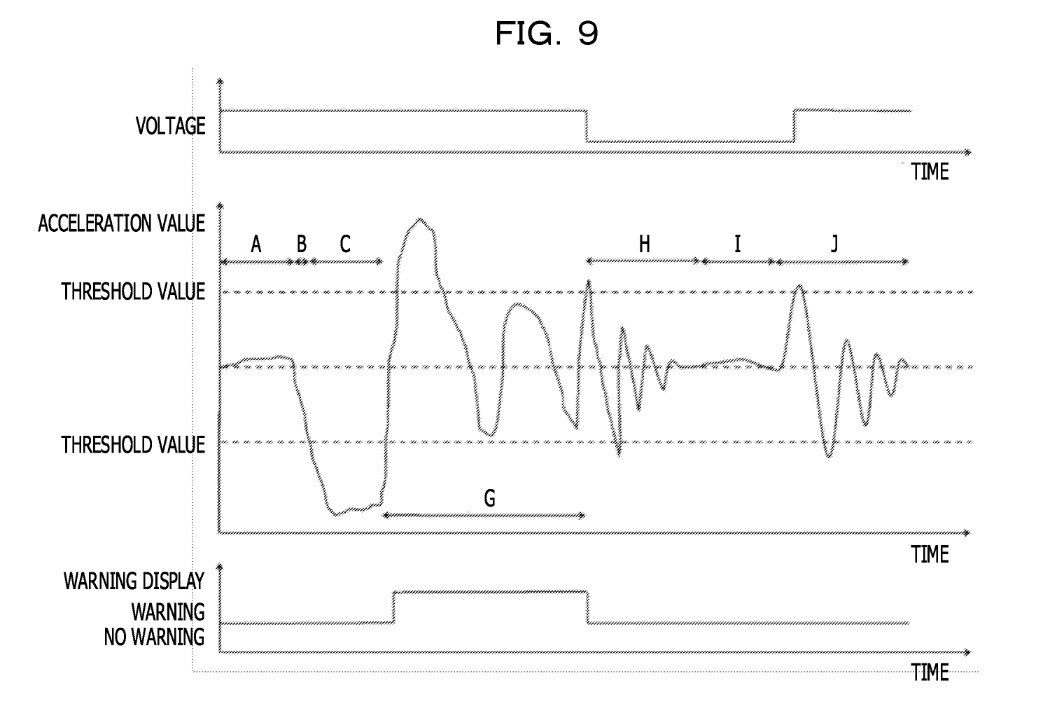

FIG. 9 is a diagram that illustrates a relationship between change of an output of the acceleration sensor 109 that is included in the information processing device 200 according to the embodiment, voltage that is detected by the connector connection detection unit 1016, and timing at which the CPU 101 performs warning display.

First, when the information processing device 200 is, for example, in the regular movement state in which the user holds the information processing device 200, as illustrated in the section A of FIG. 9, an output of the acceleration sensor 109 is changed relatively smoothly. After that, when the information processing device 200 becomes in the gravity-free state due to the fall, as illustrated in the section B of FIG. 9, an acceleration is rapidly changed. The output level of the acceleration sensor 109 is rapidly changed. In addition, as illustrated in the section C in FIG. 9, an acceleration in the free fall is kept substantially even. In the sections B and C, when an acceleration value exceeds a certain value, the determination unit 1014 outputs a retraction instruction to the HDD I/O unit 1018 and causes the HDD I/O unit 1018 to execute the head retraction processing for the HDD 112 in order to execute the crash-proof processing of the information processing device 200. The determination unit 1014 displays a message that indicates that the head retraction of the HDD has been performed, on the monitor 114 through the graphics controller 105.

After that, for example, when the fall of the information processing device 200 is avoided before the information processing device 200 falls on a floor, as illustrated in the section G of FIG. 9, the output level of the acceleration sensor 109 repeatedly moves up and down until the information processing device 200 becomes in the static state in which the fall of the information processing device 200 is stopped by the user after the output level of the acceleration sensor 109 rises rapidly. At that time, the head of the HDD 112 has been already moved to the refraction location, so that the head is not damaged. The determination unit 1014 terminates the display of the message that indicates that the head retraction of HDD has been performed on the monitor 114 through the graphics controller 105.

In addition, when the external device is mechanically coupled to the information processing device 200 by the user, the output level of the acceleration sensor 109 rises rapidly by an impact that is applied to the information processing device 200 at the time of connection of the external device as illustrated in the section H in FIG. 9. After that, until the information processing device 200 becomes in the static state, the output level of the acceleration sensor 109 moves up and down repeatedly. At the time of connection of the external device, voltage that is detected by the connector connection detection unit 1016 is changed from “High” to “Low”. Therefore, the determination unit 1014 determines that the external device is mechanically coupled to the information processing device 200. In addition, the determination unit 1014 does not display the message that indicates that the head retraction of the HDD has been performed on the monitor 114 through the graphics controller 105.

When the external device is mechanically coupled to the information processing device 200 and the information processing device 200 becomes in the static state, the acceleration sensor 109 is in a state in which gravity force alone is applied, and the output level of the acceleration sensor 109 is kept substantially even as illustrated in the section I of FIG. 9. In addition, when the external device is mechanically disconnected from the information processing device 200 by the user, the output level of the acceleration sensor 109 rises rapidly by an impact that is applied on the information processing device 200 at the time of disconnection of the external device as illustrated in the section J of FIG. 9. After that, until the information processing device 200 becomes in the static state, the output level of the acceleration sensor 109 moves up and down repeatedly. At the time of disconnection of the external device, the voltage that is detected by the connector connection detection unit 1016 is changed from “Low” to “High”. Therefore, the determination unit 1014 determines that the external device is mechanically disconnected from the information processing device 200. In addition, the determination unit 1014 does not perform the display of the message that indicates that the head retraction of the HDD has been performed on the monitor 114 through the graphics controller 105.

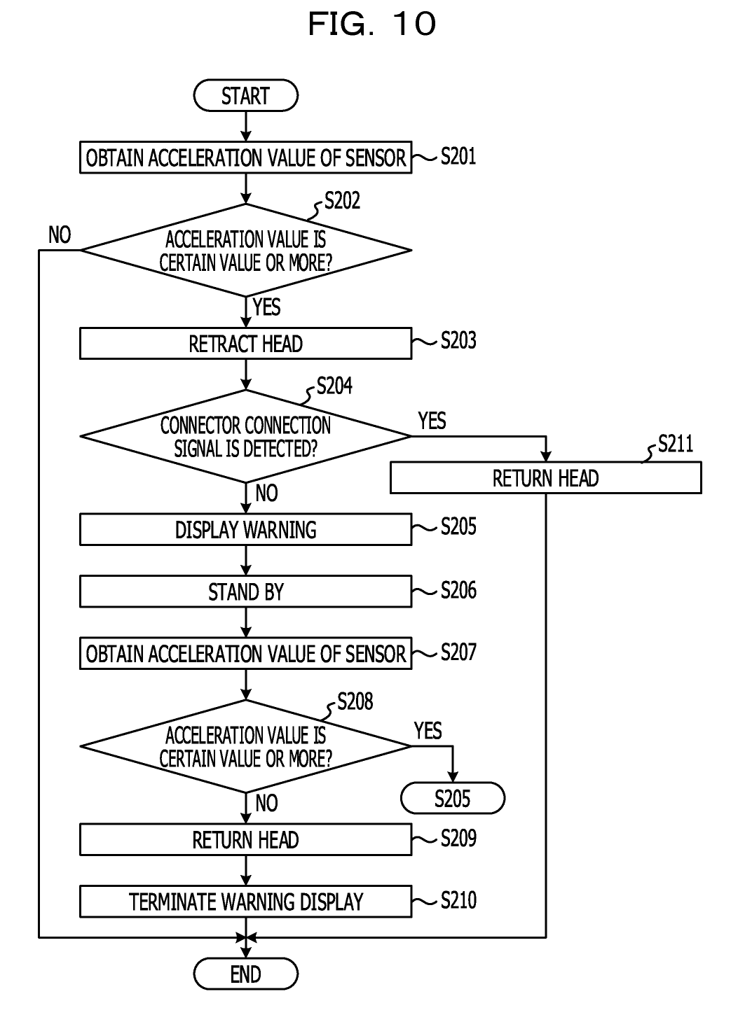

FIG. 10 is a flowchart illustrating the processing according to the embodiment. Here, the same description as that of the processing described above using FIG. 7 is omitted.

In S201, the acceleration reading unit 1012 obtains an acceleration value from the acceleration sensor 109 and transfers the obtained acceleration value to the determination unit 1014. The flow proceeds to S202.

In S202, the determination unit 1014 determines whether or not the acceleration value that is transferred from the acceleration reading unit 1012 is a certain value or more. As illustrated in the section I of FIG. 9, when the acceleration value is the certain value or more, the flow proceeds to S203. In addition, as illustrated in the section J in FIG. 9, when the acceleration value is less than the certain value, the flow ends.

In S203, the determination unit 1014 instructs the HDD I/O unit 1018 to retract the head of the HDD 112. When the HDD I/O unit 1018 receives the instruction of the head retraction, from the determination unit 1014, the HDD I/O unit 1018 retracts the head of the HDD 112. The flow proceeds to S204.

In S204, the determination unit 1014 determines whether or not the connector connection detection unit 1016 detects disconnection of the external connector 113. As illustrated in the section J of FIG. 9, when the connector connection detection unit 1016 detects the disconnection of the external connector 113, the flow proceeds to S211. In addition, as illustrated in the section I of FIG. 9, when the connector connection detection unit 1016 does not detect the disconnection of the external connector 113, the flow proceeds to S205. In the second embodiment, a case is described in which voltage that is detected by the connector connection detection unit 1016 is changed from “Low” to “High”. As illustrated in the section J of FIG. 9, even in the case in which the acceleration value exceeds the certain value, when it is detected that the external device is mechanically disconnected from the information processing device 200, it is determined that an impact is applied to the information processing device 200 in order to disconnect the external device from the information processing device 200 mechanically. The determination unit 1014 terminates the crash-proof processing of the information processing device 200.

In S211, the determination unit 1014 instructs the HDD I/O unit 1018 to return the head of the HDD 112. The HDD I/O unit 1018 returns the head of the HDD 112 when the HDD I/O unit 1018 receives the head return instruction from the determination unit 1014. The flow ends.

As described above, in the second embodiment, when it is detected that the external device is mechanically disconnected from the information processing device 200 with respect to a temporary impact that is applied to the information processing device 200, the return of the HDD from the protected state is advanced. Therefore, a time period of false detection may be reduced. In the second embodiment, even when the function of protecting the HDD is excessively performed for the impact that occurs at the time of mechanical disconnection of the external device, the head is returned immediately. Therefore, the user does not feel the inconvenience.

As described above, the information processing device according to the embodiments is exemplarily described above, however, the embodiments are not limited to the above-described specific embodiments, and various modifications and alternations can be made without departing from the scope of claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
an acceleration sensor that detects an acceleration;
a processor that is coupled to the acceleration sensor and configured to:
cause a storage that is included in the information processing device to execute crash-proof processing based on the acceleration detected by the acceleration sensor, and
cause the storage to terminate the crash-proof processing when the processor detects that an external device is mechanically coupled to the information processing device.

2. The information processing device according to claim 1, wherein
the storage includes a medium and a head that accesses the medium, and
the processor is configured to:
control the head to be retracted when the acceleration sensor detects an acceleration that is a certain value or more, and
control the head to be returned when the processor detects that the external device is coupled to the information processing device after the head is retracted.

3. The information processing device according to claim 1, wherein
the storage includes a medium and a head that accesses the medium, and
the processor is configured to:
control the head to be retracted when the acceleration sensor detects an acceleration that is a certain value or more, and
control the head to be returned when the processor detects that the external device is mechanically disconnected from the information processing device after the head is retracted.

4. The information processing device according to claim 1, wherein
the acceleration sensor detects variation in an acceleration that is added to each of two axes or three axes and performs analogue output.

5. The information processing device according to claim 1, wherein
the processor is configured to detect that the external device is mechanically coupled to the information processing device by detecting change in voltage.

6. The information processing device according to claim 1, wherein
the processor is configured to detect that the external device is mechanically coupled to the information processing device by a plug-in function.

7. The information processing device according to claim 1, wherein
the processor is configured to cause the storage to terminate the crash-proof processing when the processor detects that a connector of the external device is mechanically coupled to the information processing device.

8. An information processing method that is implemented by an information processing device, the information processing method comprising:
causing a storage that is included in the information processing device to execute crash-proof processing based on an acceleration that is detected by an acceleration sensor; and
causing the storage to terminate the crash-proof processing when detecting that an external device is mechanically coupled to the information processing device.

9. A computer-readable recording medium storing a program causing a processor to execute an operation, the operation comprising:
causing a storage that is included in an information processing device to execute crash-proof processing based on an acceleration that is detected by an acceleration sensor that is coupled to the processor; and
causing the storage to terminate the crash-proof processing when the processor detects that an external device is mechanically coupled to the information processing device.
